(19) United States
(12) Patent Application Publication
(10) Pub. No.: US 2005/0128510 A1
(43) Pub. Date: Jun. 16, 2005

(54) Method for selecting images for action by an imaging apparatus

(76) Inventor: Michael Clark Campbell, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/736,872

(22) Filed: Dec. 16, 2003

(51) Int. Cl. G06K 1/00

(52) U.S. Cl. 358/1.15

(57) ABSTRACT

A method for selecting images from a plurality of images obtained from a digital device for printing with an imaging apparatus, includes the steps of printing a thumbnail printout, the thumbnail printout including a plurality of thumbnails corresponding to the plurality of images; generating a selection sheet from the thumbnail printout by placing a first designation mark on the thumbnail printout for each thumbnail of the plurality of thumbnails corresponding to each image of the plurality of images on which a first action is to be taken; detecting the first designation mark by scanning the selection sheet with the scanner; printing a confirmation for confirming to a user that each image on which the first action to be taken is designated; and performing the first action based on detecting the first designation mark.

### BACKGROUND OF THE INVENTION

1. Field of the Invention

The present invention relates to an imaging apparatus, and, more particularly, to methods for selecting images for performing actions thereon using the imaging apparatus, such as printing the images.

2. Description of the Related Art

In recent years, both professional and consumer users have increasingly turned to the use of digital cameras. The images taken by digital cameras are typically stored in a removable memory associated with the camera, for example, a memory card or a floppy disk. These images can be subsequently modified by the user using built-in features of the digital camera, such as changing contrast or color depth. The images can also be downloaded onto a typical personal computer, and modified using commercially available specialized software. In either case, the images can then be printed using conventional electrostatic or ink jet printers, preferably in a photo-quality print mode. Many current digital cameras allow the user to connect the camera directly to a printer. With such cameras, the user can print the images without using a personal computer, for example, using the printer in a stand-alone mode.

Printing in a stand-alone mode has the advantage of printing without the necessity of booting up a personal computer, which can be time consuming. In addition, the user may not be able to afford to own a personal computer, but may own only a printer for printing photos, which is considerably less expensive than the typical personal computer system including a printer. In such cases, it is desirable to display the contents of the camera's memory to allow the user to select the images that the user wishes to print. In one method, the photo printer has a small color display screen and input buttons for displaying and selecting the desired image or group of images. The disadvantage with this approach is the cost involved, for example, the cost of the color screen, and potential usability issues associated with using a small display screen, such as readability, and the resolution of displayed images.

In another method, a thumbnail sheet is printed by an all-in-one (AIO) unit, which includes a printer and conventional scanner. The user then selects photos for printing by filling in selection circles or check boxes, and inserts the thumbnail sheet back into the AIO unit, which scans the thumbnail sheet and prints the selected images. However, marking the desired photos and print options may be difficult and/or unintuitive for some people. For example, filling in a check box or a circle may be difficult for users who have trouble with their eyesight. Also, groups of check boxes or circles might be confusing to the user. Moreover, if the thumbnail sheet is inserted improperly, the wrong image might be printed, or some other adverse action might take place, for example, if the printer does not recognize that the thumbnail sheet has been inserted improperly. Even if no adverse action takes place, the user may have to go through the trouble of re-inserting the thumbnail sheet into the unit.

Also, if the user has inadvertently selected the wrong thumbnail, e.g., by filling in the wrong circle or check box, accidentally selected more than one image by marking outside of the circle or check box, or did not insert the thumbnail sheet in the proper orientation, the wrong image or images might be printed. Given the high cost of photo quality paper, the cost of ink, and the time required for printing photo quality images, it is desirable to avoid printing the wrong image.

What is needed in the art is a method for clear, intuitive, and sure selection of images on which to perform an action, such as for example printing.

### SUMMARY OF THE INVENTION

The present invention provides a method for clear, intuitive, and sure selection of images on which to perform an action, such as for example, printing.

The invention, in one form thereof, relates to a method for selecting images from a plurality of images obtained from a digital device for printing with an imaging apparatus, the imaging apparatus having a scanner and accessing a memory storing the plurality of images. The method includes the steps of printing a thumbnail printout, the thumbnail printout including a plurality of thumbnails corresponding to the plurality of images; generating a selection sheet from the thumbnail printout by placing a first designation mark on the thumbnail printout for each thumbnail of the plurality of thumbnails corresponding to each image of the plurality of images on which a first action is to be taken; detecting the first designation mark by scanning the selection sheet with the scanner; printing a confirmation for confirming to a user that each image on which the first action to be taken is designated; and performing the first action based on detecting the first designation mark.

The invention, in another form thereof, relates to a method for selecting images from a plurality of images obtained from a digital device for printing with an imaging apparatus, the imaging apparatus having a scanner and accessing a memory storing the plurality of images. The method includes the steps of printing a thumbnail printout, the thumbnail printout including a plurality of thumbnails corresponding to the plurality of images; generating a selection sheet from the thumbnail printout by placing a first designation mark directly on each thumbnail of the plurality of thumbnails corresponding to each image of the plurality of images on which a first action is to be taken; detecting the first designation mark by scanning the selection sheet with the scanner; and performing the first action based on detecting the first designation mark.

The invention, in yet another form thereof, relates to a method for selecting images from a plurality of images obtained from a digital device for printing with an imaging apparatus, the imaging apparatus having a scanner and accessing a memory storing the plurality of images. The method includes the steps of printing a thumbnail printout, the thumbnail printout including a plurality of thumbnails corresponding to the plurality of images and at least one orientation symbol for indicating an orientation of the thumbnail printout; generating a selection sheet from the thumbnail printout by placing a first designation mark on the thumbnail printout for each thumbnail of the plurality of thumbnails corresponding to each image of the plurality of images on which a first action is to be taken; detecting the first designation mark by scanning the selection sheet with the scanner; detecting the at least one orientation symbol by scanning the selection sheet with the scanner; determining the orientation of the selection sheet based on the at least one orientation symbol; and performing the first action based on detecting the first designation mark and based on determining the orientation.

The invention, in still another form thereof, relates to a method for selecting images from a plurality of images obtained from a digital device for printing with an imaging apparatus, the imaging apparatus having a scanner and accessing a memory storing the plurality of images. The method includes the steps of printing a thumbnail printout, the thumbnail printout including a plurality of thumbnails corresponding to the plurality of images; generating a selection sheet from the thumbnail printout by placing a first designation mark on the thumbnail printout for each thumbnail of the plurality of thumbnails corresponding to each image of the plurality of images on which a first action is to be taken, and placing a second designation mark on the thumbnail printout for each thumbnail of the plurality of thumbnails corresponding to each image of the plurality of images on which a second action is to be taken, the second designation mark being different from the first designation mark, and the second action being different from the first action; detecting the first designation mark and the second designation mark by scanning the selection sheet with the scanner; performing the first action based on detecting the first designation mark; and performing the second action based on detecting the second designation mark.

An advantage of the present invention is that it may be implemented in a low cost imaging apparatus operating in a stand alone mode.

Another advantage of the present invention is that the cost of a display screen and conventional scanner may be avoided.

An advantage of the present invention, in some embodiments thereof, is that the user receives a confirmation of which images are designated to be printed, and which are designated for other actions, such as deleting, thus avoiding costs associated with printing the wrong image or deleting the wrong image, such as the high cost of photo quality paper, the cost of ink, and the time required printing photo quality images, or the loss of an image.

Another advantage of the present invention, in some embodiments thereof, is that marking directly on a thumbnail to select the image allows a selection method that is intuitive, clear, and unambiguous.

Yet another advantage of the present invention, in some embodiments thereof, is that the selection sheet can be inserted in any of four orientations, allowing for ease of use, and the prevention of mistakes in printing or deleting images.

### BRIEF DESCRIPTION OF THE DRAWINGS

The above-mentioned and other features and advantages of this invention, and the manner of attaining them, will become more apparent, and the invention will be better understood by reference to the following description of embodiments of the invention taken in conjunction with the accompanying drawings, wherein:

FIG. 1 is a diagrammatic depiction of an imaging system that utilizes the present invention.

FIG. 2 is an illustration of a selection sheet used in conjunction with the present invention to perform an action on an image, e.g., printing.

FIG. 2A is a table containing a partial listing of actions that may be performed by an imaging apparatus in accordance with the present invention.

FIG. 2B is a table containing a partial listing of print options.

FIG. 3 is a flowchart depicting a method according to the present invention.

FIG. 4 is another illustration of a selection sheet used in conjunction with the present invention to perform one action, e.g., printing, on one image, and to perform another action on another image, e.g., deleting the image from memory.

FIGS. 5A-5D depict alternative approaches to applying a designation mark to a thumbnail.

FIG. 6 illustrates a confirmation that images have been designated, in the form of a confirmation sheet, in accordance with the present invention.

FIG. 7 is an illustration of a thumbnail printout depicting a known location of a thumbnail in accordance with the present invention.

FIG. 8 is a flowchart depicting another method according to the present invention.

FIG. 9 is a flowchart depicting yet another method according to the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

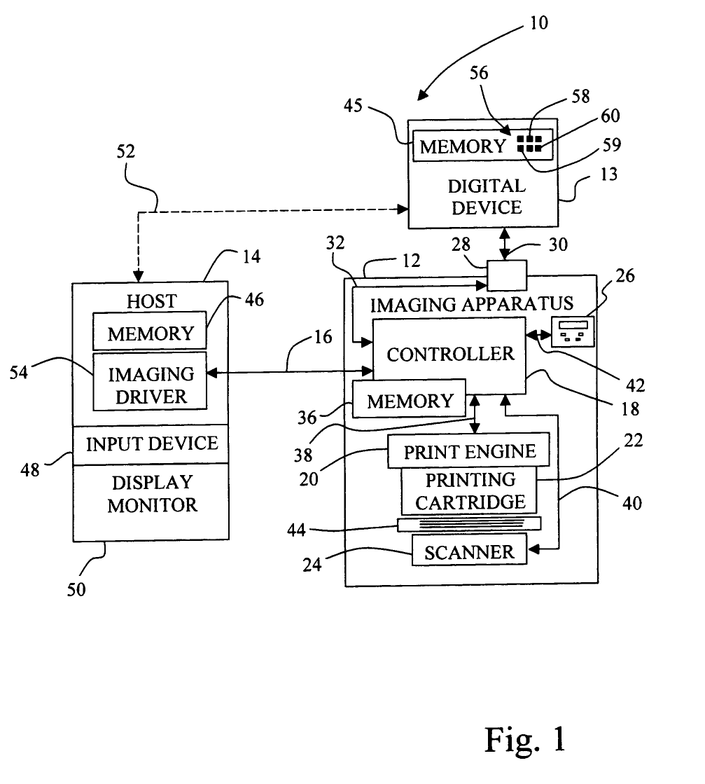

Referring now to the drawings, and particularly to FIG. 1, there is shown a diagrammatic depiction of an imaging system 10 embodying the present invention. Imaging system 10 includes an imaging apparatus 12, a digital device 13, and a host 14. Imaging apparatus 12 communicates with host 14 via a communications link 16.

Imaging apparatus 12 can be, for example, an ink jet printer and/or copier, an electrophotographic printer and/or copier, or an all-in-one (AIO) unit that includes a printer, a scanner, and possibly a fax unit. Imaging apparatus 12 includes a controller 18, a print engine 20, a printing cartridge 22, a scanner 24, and a user interface 26. Imaging apparatus 12 also includes an interface 28 for communication with digital device 13 via a communication link 30. Interface 28 communicates with controller 18 via a communication link 32. Interface 28 and communication link 30 provide communication between imaging apparatus 12 and digital device 13, respectively, via a typical communication protocol, such as a universal serial bus (USB).

Controller 18 includes a processor unit and associated memory 36, and may be formed as one or more Application Specific Integrated Circuits (ASIC). Alternatively, memory 36 may be in the form of a separate electronic memory, a hard drive, a CD drive, or any memory device convenient for use with controller 18. Controller 18 may be a printer controller, a scanner controller, or may be a combined printer and scanner controller. Controller 18 communicates with print engine 20 via a communications link 38, with scanner 24 via a communications link 40, and with user interface 26 via a communications link 42. Controller 18 serves to process print data and to operate print engine 20 during printing, as well at to operate scanner 24 and process data obtained via scanner 24.

In the context of the examples for imaging apparatus 12 given above, print engine 20 can be, for example, an ink jet print engine or a color electrophotographic print engine, configured for forming an image on a substrate 44, such as a sheet of paper, transparency or fabric. As an ink jet print engine, print engine 20 operates printing cartridge 22 to eject ink droplets onto substrate 44 in order to reproduce text or images, etc. As an electrophotographic print engine, print engine 20 causes printing cartridge 22 to deposit toner onto substrate 44, which is then fused to substrate 44 by a fuser (not shown), in order to reproduce text or images, etc.

Scanner 24 is a conventional scanner. Alternatively scanner 24 is any suitable sensor capable of scanning, e.g. an alignment sensor for aligning a printhead of imaging apparatus 12, such as printing cartridge 22.

Digital device 13 includes a memory 45, and may be, for example, a digital camera having a memory or a video camera having a memory. Alternatively, digital device 13 with memory 45 is a floppy drive, a hard drive, a CD drive, a DVD drive, a memory card, or any digital device capable of storing images and communicating with imaging apparatus 12. When digital device 13 is in communication with imaging apparatus 12 via communication link 30, imaging apparatus 12 has access to memory 45.

Host 14 may be, for example, a personal computer, including memory 46, an input device 48, such as a keyboard, and a display monitor 50. Digital device 13, may be coupled to host 14 via a communication link 52, depicted as a dashed line. Host 14 further includes a processor, input/output (I/O) interfaces, memory, such as RAM, ROM, NVRAM, and at least one mass data storage device, such as a hard drive, a CD-ROM and/or a DVD unit.

During operation, host 14 includes in its memory a software program including program instructions that function as an imaging driver 54, e.g., printer/scanner driver software, for imaging apparatus 12. Imaging driver 54 is in communication with controller 18 of imaging apparatus 12 via communications link 16. Imaging driver 54 facilitates communication between imaging apparatus 12 and host 14, and may provide formatted print data to imaging apparatus 12, and more particularly, to print engine 20, to print an image. Alternatively, however, all or a portion of imaging driver 54 may be located in controller 18 of imaging apparatus 12.

In some circumstances, it is desirable to operate imaging apparatus 12 without host 14, for example, in a stand-alone mode. In a stand-alone operating mode, imaging apparatus 12 is capable of functioning without host 14. For example, a user of imaging apparatus 12 may take some pictures with digital device 13, which stores the images in memory 45. After taking the pictures, the user may desire to quickly and easily work with images obtained from digital device 13 without turning on host 14, due to the fact that host 14 may require a considerable amount time to boot up. Also, a user may not have access to or own a computer such as host 14. Accordingly, the present invention is directed to allowing a user to perform actions on images obtained by or stored in digital device 13, using imaging apparatus 12 in a stand-alone mode. As such, imaging apparatus 12 is in direct communication with digital device 13, via interface 28 and communication link 30, including accessing memory 45 that stores a plurality of images 56. The plurality of images 56 are transferred or copied from memory 45 to a memory associated with imaging apparatus 12, such as memory 36. The transfer may be made, for example, by accessing a transfer function on user interface 26 or digital device 13. This allows imaging apparatus 12 to perform actions with respect to plurality of images 56. Alternatively, imaging apparatus 12 may perform actions with respect to plurality of images 56 simply by accessing memory 45 without transferring plurality of images 56.

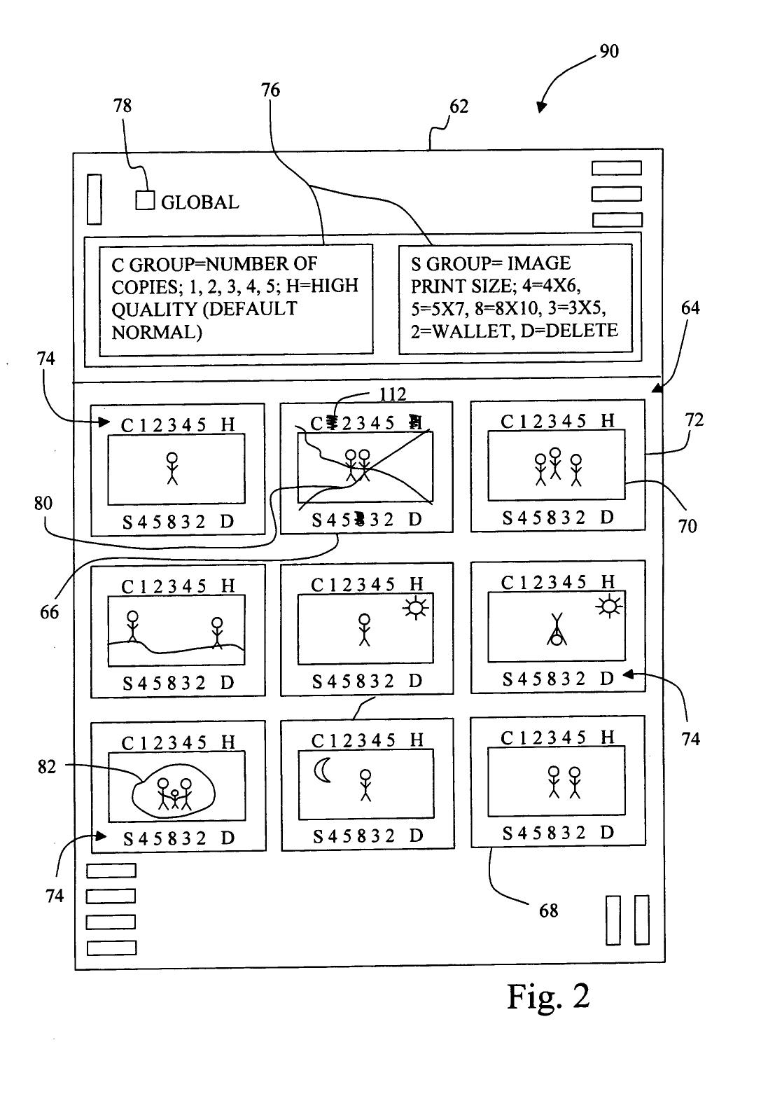

Referring now to FIG. 2, there is depicted a thumbnail printout 62 that includes a plurality of thumbnails 64 corresponding to plurality of images 56, for example, including thumbnail 66 corresponding to image 58 and thumbnail 68 corresponding to image 60. Each thumbnail of plurality of thumbnails 64 includes a thumbnail image 70 and a thumbnail frame 72. It will be understood, however, that each of plurality of thumbnails 64 may include only thumbnail image 70, without thumbnail frame 72. Thumbnail printout 62 also includes a plurality of print option symbols 74 corresponding to a plurality of print options 76 that may be selected for printing an image or images.

In practicing the present invention, as described in the following embodiments, the user of imaging apparatus 12 selects images from plurality of images 56 on which the user desires to perform an action, such as printing, by placing one or more designation mark on thumbnail printout 62. It will be understood that, in addition to printing, many actions are possible within the scope of the present invention, including, without limitation, with reference to FIG. 2A, actions 77 such as copying images to memory 36; copying images to another storage device; inhibiting printing, for example if the user chooses to print all images except a select few that are inhibited from being printed; deleting, for example deleting images from memory 36 and or memory 45; changing image parameters, for example, changing from a normal image to a negative, changing a resolution of an image, compressing an image; as well as other operations that may be performed with respect to an image.

Although only certain print options/print option symbols are depicted on thumbnail printout 62, it will be understood that plurality of print options 76 includes, but is not limited to, with reference to FIG. 2B, a selection of a number of copies; print quality settings, such as multi-pass printing, print resolution, color, back and white, or other color-related settings; printed size; page layout for printing one image or several images on a page; paper size selection; page orientation for printing; and an output type, e.g., a negative image. Further, it will be understood that more than one print option of plurality of print options 76 may be applied to any given image, and that different sets of print options from plurality of print options 76 may be applied to different images. In addition, although depicted in close proximity to the thumbnails, the print option symbols may be located at any convenient location on thumbnail printout 62. Further, it will be understood that all images selected for printing may be printed using the same print options by selecting, for example, a global print option 78. Print options may also be selected by choosing both from plurality of print option symbols 74 and a global print option 78.

Various algorithms may be used for detecting designation marks, and for detecting the configuration of each designation mark. For example, designation marks on a page may be detected using scanner 24 in the form of a conventional scanner, and using optical character recognition (OCR) software residing in memory 36 of controller 18.

If OCR software is used to detect the designation marks, in order to prevent errors by the OCR software due to interference of the thumbnail image with the designation mark, drop-out inks having a known spectral absorptivity or “print contrast signal” (PCS) may be used to print plurality of thumbnails 64. The drop-out inks would have, for example, a PCS level of 0.4 or less. Here, scanner 24 has a threshold PCS detection level above approximately 0.4, and accordingly, would not detect plurality of thumbnails 64, but instead, would “see” only the designation marks.

Alternatively, imaging apparatus 12 may electronically mask each thumbnail of plurality of thumbnails 62, for example, by subtracting from each scanned thumbnail, the known pixels values of the thumbnail image stored in memory 36. If a number of non-white pixels above a threshold level remained, after the subtraction step, imaging apparatus 12 determines that a designation mark has been detected. The configuration of the group of remaining non-white pixels could be detected as corresponding to a particular known configuration, for example, wherein the manufacturer of imaging apparatus 12 specifies that certain configurations of designation marks should be used. For example, configurations in the form of a handwritten “X” 80, and/or any other alpha-numeric symbol, such as a hand-drawn circle 82. In addition, OCR software could otherwise be used to detect the configuration. It will be understood that a designation mark according to the present invention may take any convenient form.

In addition to detecting the designation marks and their configurations, imaging apparatus 12 also detects the location of each designation mark by detecting the X and Y coordinates e.g., of the centroid of the group of remaining non-white pixels. The locations of each thumbnail and print option symbol are known to imaging apparatus 12, having been stored in memory 36 before or during the printing of thumbnail printout 62. The locations of the designation marks are then used in conjunction with the known locations of the respective thumbnails to determine the corresponding images on which actions will be performed, and to determine which print options are selected for each image sought to be printed.

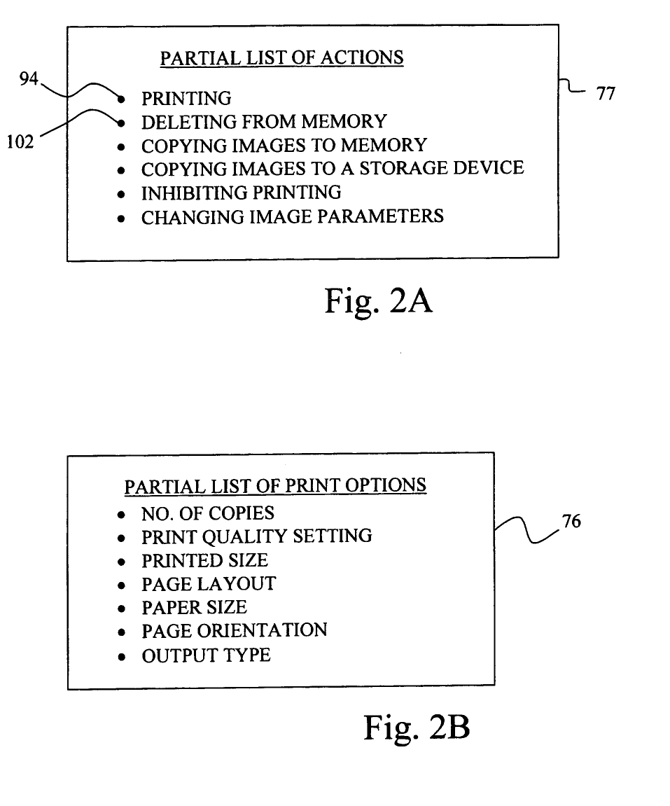

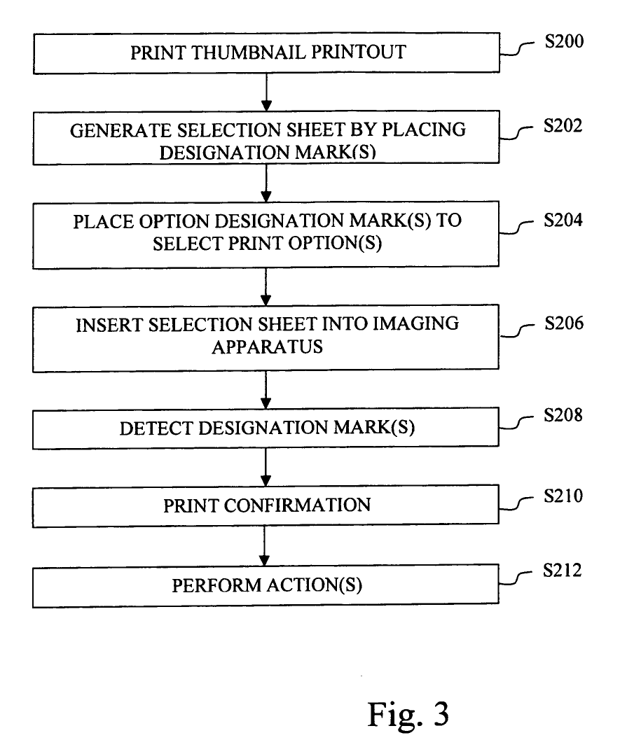

Referring now to FIG. 3, there is generally depicted a method for selecting images from the plurality of images 56 obtained from digital device 13 for performing an action, such as printing, with imaging apparatus 12. The method is described with reference primarily to FIG. 4, and also to FIGS. 2A, 2B, and 5A-7.

At a step S200, the function of printing thumbnail printout 62 with plurality of thumbnails 64 corresponding to plurality of images 56 is performed, using imaging apparatus 12. Thumbnail printout 62 also includes plurality of print option symbols 74, including, for example, a print option symbol 84, a print option symbol 86, and a print option symbol 88.

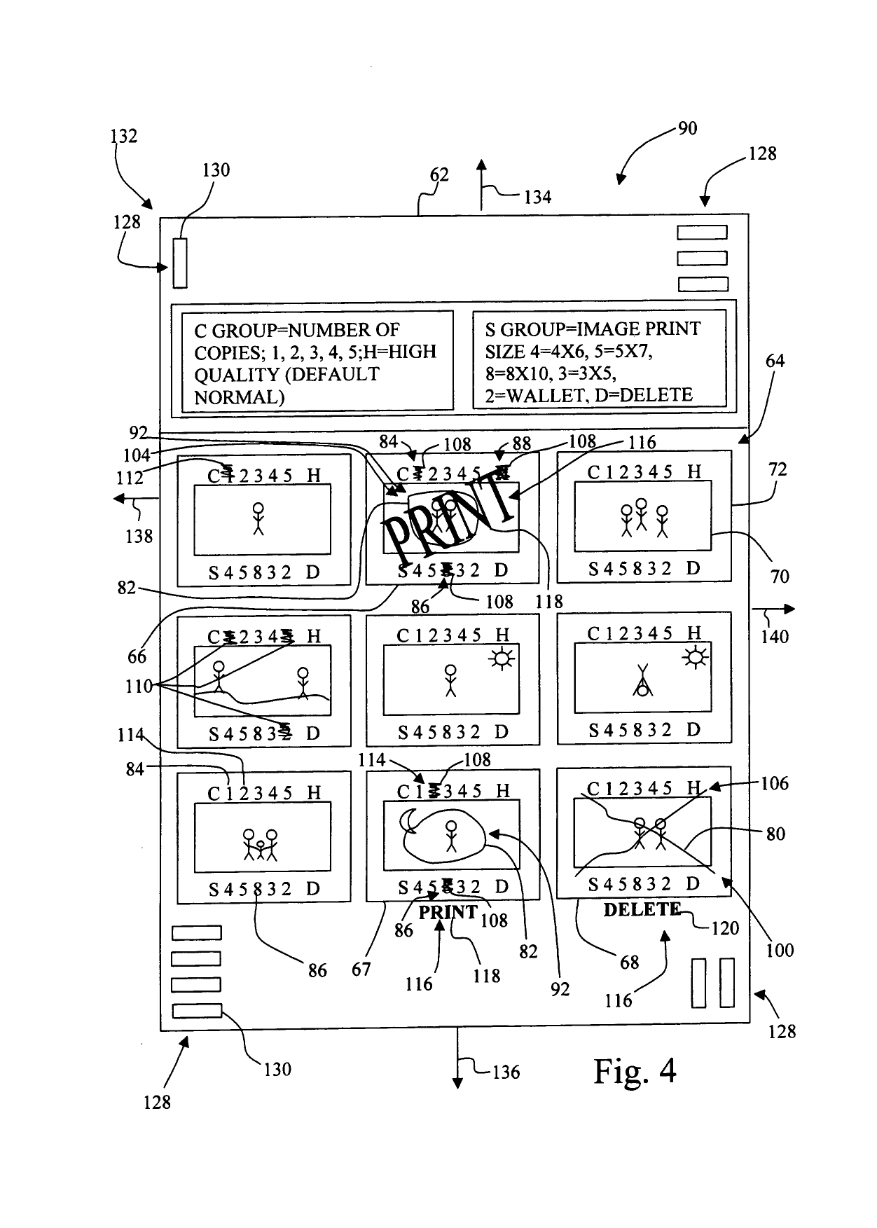

At a step S202 selection sheet 90 is generated from thumbnail printout 62 by placing a designation mark 92 on thumbnail printout 62 for each thumbnail of plurality of thumbnails 64 corresponding to each image of plurality of images 56 on which an action 94 is to be taken. For example, as depicted in FIG. 5A, designation mark 92 in the form of hand-drawn circle 82 is placed adjacent thumbnail 66 corresponding to image 58. In another example, as depicted in FIG. 5B, designation mark 92 in the form of handwritten “X” 80 is placed in a check box 96 for thumbnail 66 corresponding to image 58. Alternatively, designation mark 92 may be made by filling in a fill-in circle 98, as depicted in FIG. 5C, or making any other convenient character or mark. Another designation mark 100 is placed on thumbnail printout 62 for each thumbnail of plurality of thumbnails 64 corresponding to each image of plurality of images 56 on which a another action, such as an action 102, is to be taken, wherein designation mark 100 is different from designation mark 92, and action 102 is different from action 94. As depicted in FIG. 5D, designation mark 100 is placed adjacent thumbnail 68 corresponding to image 60. Designation mark 92 has a configuration 104 in the form of hand-drawn circle 82, and designation mark 100 has a configuration 106, different from configuration 104, in the form of handwritten “X” 80. Action 94 is printing image 58, whereas action 102 is deleting image 60 from memory 36 and/or memory 45.

It will be understood that the user may select as many of plurality of images 56 by marking each with designation mark 92 or designation mark 100. In addition, the configuration of each of designation mark 92 and designation mark 100 may take any convenient form, such as an alphanumeric symbol other than handwritten “X” 80 or hand-drawn circle 82. The user may select as many of plurality of images 56 as desired, by marking with designation mark 92 and/or designation mark 100, so that action 94 and action 102 are performed on the selected images, respectively. It will also be understood that additional designation marks, corresponding to additional actions, may be used within the context of the present invention.

At a step S204, an option designation mark 108, which is one of a plurality of option designation marks 110, is placed at one or more print option symbols of plurality of print option symbols 74 on selection sheet 90 to designate one or more desired print option of plurality of print options 76 to be used in printing the desired image or images.

Each image of plurality of images 56 on which an action is to be taken includes at least a first image on which the action is to be taken and at least a second image on which the action is to be taken. The user may print different images with different print options. In such a case, the user places an option designation mark 108 for at least one print option symbol corresponding to at least one print option 76 for an image upon which an action is to be taken, and places an option designation mark 108 for a different at least one print option symbol corresponding to a different at least one print option 76 for an image upon which the action is to be taken. For example, in FIG. 4, option designation mark 108 in the form of a “scribble” 112 is used to mark print option symbol 84, print option symbol 86, and print option symbol 88 for thumbnail 66, corresponding to image 58 upon which action 94 is to be taken. In addition option designation mark 108, in the form of “scribble” 112, is used to mark a print option symbol 114 and print option symbol 86 for thumbnail 67, corresponding to image 59, upon which action 94 is also to be taken. In both cases, action 94 is printing the designated images using the print options 76 selected for each image.

At a step S206, selection sheet 90 is inserted into imaging apparatus 12, for example, into an automatic sheet feeder or a manual feed slot in imaging apparatus 12.

At a step S208, imaging apparatus 12 detects each designation mark by scanning selection sheet 90 with scanner 24. For example, scanner 24 scans selection sheet 90 to detect designation mark 92, a second designation mark, e.g., designation mark 100, and each option designation mark 108. Using the detection algorithms described above, detection step S208 includes detecting the configurations of each designation mark, for example, detecting configuration 104 of designation mark 92 as being hand-drawn circle 82, and detecting configuration 106, respectively, of designation mark 100 as being handwritten “X” 80.

At a step S210, a confirmation 116 is printed, for confirming to the user that each image for which an action to be taken is designated. Confirmation 116 is printed on selection sheet 90, wherein the printing of confirmation 116 includes printing a first confirmation mark printed at one of a location adjacent each thumbnail and on each thumbnail, corresponding to each image on which an action is to be taken. Confirmation 116 includes printing a confirmation mark 118 and a confirmation mark 120 different from confirmation mark 118. For example, a confirmation mark 118, in the form of the word “PRINT”, is printed on thumbnail 66 to confirm that corresponding image 58 is designated for printing, and is printed adjacent thumbnail 67 to confirm that corresponding image 59 is to be printed. A confirmation mark 120 in the form of the word “DELETE” is printed adjacent thumbnail 68 to confirm that corresponding image 60 is to be deleted from memory 36 and/or memory 45.

The printing of confirmation 116 includes printing an option confirmation mark 122 at one of a location adjacent the corresponding print option symbol and on the print option symbol. For example, as shown in FIG. 5A, option confirmation mark 122 in the form of a checkmark is printed on print option symbol 84, print option symbol 86, and print option symbol 88. As depicted in FIG. 5B, option confirmation mark 122 is printed adjacent print option symbol 84, print option symbol 86, and print option symbol 88.

Where more than one print option is selected by the user, confirmation 116 includes printing option confirmation mark 122 at print option symbols of plurality of print option symbols 74 corresponding to each at least one print option and each different at least one print option. For example, print option symbol 84, print option symbol 86, and print option symbol 88 with respect to thumbnail 66; and print option symbol 86 and print option symbol 114 with respect to thumbnail 67.

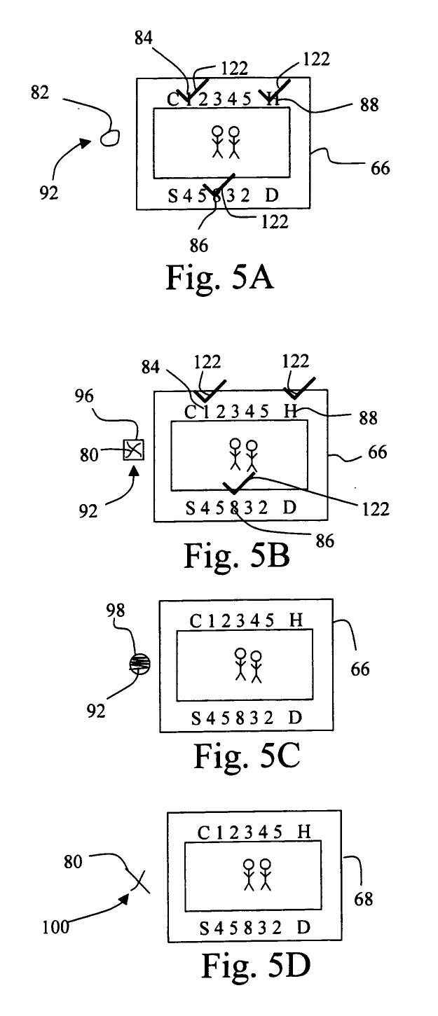

Alternatively, confirmation 116 is printed on a separate sheet, for example, with reference to FIG. 6, wherein printing the confirmation includes printing each designated thumbnail, e.g., thumbnail 66 and thumbnail 67, corresponding to each image on which an action is to be taken. In addition, confirmation 116 includes printing each selected print option symbol. For example, with reference to FIG. 6, printing print option symbol 84, print option symbol 86, and print option symbol 88 with respect to thumbnail 66; and print option symbol 86 and print option symbol 114 with respect to thumbnail 67.

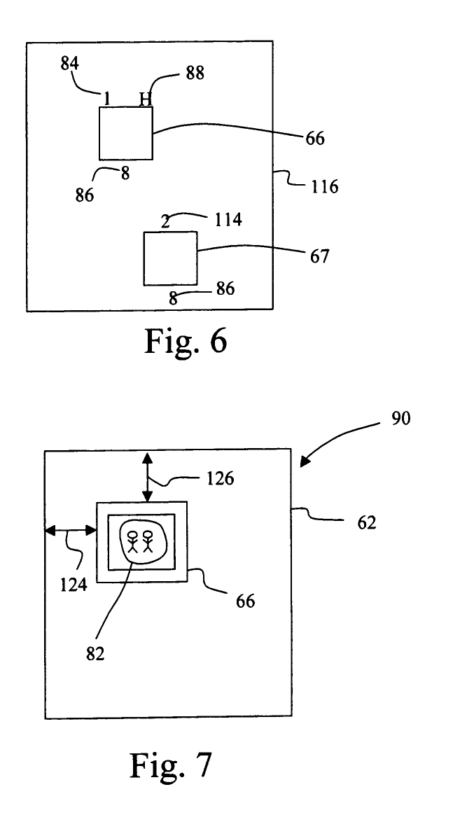

At a step S212, in response to user input, for example, via user interface 26, imaging apparatus 12 performs action 94 based on detecting designation mark 92 and based on the known location of each thumbnail, e.g., thumbnail 66. For example, the location of designation mark 92, with respect to the known location of thumbnail 66 at “X” coordinate 124 and “Y” coordinate 126 (reference FIG. 7), allows for a determination by imaging apparatus 12 that thumbnail 66 has been selected. If a print option is selected, step S212 includes printing each image on which an action is to be taken, using the print option, based on the known location of the print option symbol. For example, printing image 58, on which action 94 is to be taken, using a print option 76 based on a known location of print option symbol 84 and the detected location of option designation mark 108. Here, action 94 is printing. Alternatively, however, action 94 may be any action, such as one of the previously described actions, for example, inhibiting image 58 from printing, or deleting image 58 from memory 36 and/or memory 45.

If more than one image is selected for the action of printing, and different print options are desired for each respective image, step S212 includes, for example, printing image 58 using at least one print option 76 of plurality of print options 76, and printing image 59 using a different at least one print option 76 of plurality of print options 76.

If more one action is desired for a particular image or images, and another action is desired for another image or images, step S212 includes performing both such actions on the respective images, without the need to re-mark and reinsert selection sheet 90 into imaging apparatus 12. For example, step S212 includes performing both action 94 on image 58 and action 102 on image 60 based on detecting both designation mark 92 and designation mark 100, respectively, and based on detecting, for example, configuration 104 of designation mark 92 in the form of hand-drawn circle 82, and configuration 106 of designation mark 100 in the form of handwritten “X” 80, respectively. Action 94 is, for example, printing image 58, and action 102 is, for example, deleting image 60 from memory 36 and/or memory 45.

In a case where the user wishes to print all of plurality of images 56 except for a certain image or certain images, step S212 includes printing all images except for those images designation for the action of inhibiting printing.

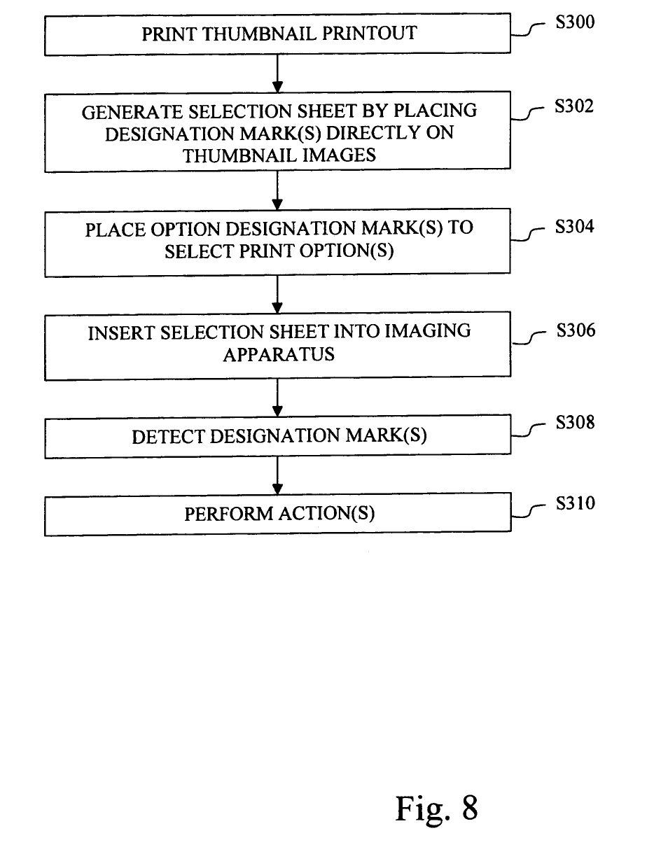

Referring now to FIG. 8, there is generally depicted another method for selecting images from the plurality of images 56 obtained from digital device 13 for performing an action, such as printing, with imaging apparatus 12. This method is described with reference primarily to FIG. 4, and also with reference to FIGS. 2A, 2B, and 7.

At a step S300, the function of printing thumbnail printout 62 with plurality of thumbnails 64 corresponding to plurality of images 56 is performed, using imaging apparatus 12. Thumbnail printout 62 also includes plurality of print option symbols 74, including, for example, print option symbol 84, print option symbol 86, and print option symbol 88.

At a step S302 selection sheet 90 is generated from thumbnail printout 62 by placing a designation mark 92 directly on each thumbnail of plurality of thumbnails 64 corresponding to each image of plurality of images 56 on which an action 94 is to be taken. For example designation mark 92 is placed on thumbnail 66 corresponding to image 58. Another designation mark 100 is placed directly on each thumbnail of plurality of thumbnails 64 corresponding to each image of plurality of images 56 on which a another action, such as action 102, is to be taken, wherein designation mark 100 is different from designation mark 92, and action 102 is different from action 94. As depicted in FIG. 4, designation mark 100 is placed on thumbnail 68 corresponding to image 60. Designation mark 92 has a configuration 104 in the form of hand-drawn circle 82, and designation mark 100 has a configuration 106, different from configuration 104, in the form of handwritten “X” 80. Action 94 is printing image 58, whereas action 102 is deleting image 60 from memory 36 and/or memory 45.

In this embodiment of present invention, the placement of designation marks directly on a thumbnail is advantageous relative to other marking methods, for example, marking a check box, such as a check box 96, filling in a circle, such as fill-in circle 98 or marking adjacent to a thumbnail, because marking directly on a thumbnail is more intuitive to the user in that the user marks the object of his/her desire directly, rather than requiring the additional mental step of seeking and selecting the appropriate location to make a designation mark. In addition, placing an “X”, such as handwritten “X” 80, is an intuitive method of selecting for deletion, which allows for quicker and easier marking by the user. Further, marking directly on the thumbnail reduces the amount of printing that would be required to print check boxes or the like, thus saving ink. Additionally, the absence of check boxes allows for a less cluttered appearance of thumbnail printout 62, thus preventing confusion for the user. Furthermore, marking directly on the image may be easier and less confusing, especially for users with poor eyesight, such as elderly users, particularly considering that thumbnail images are typically larger and more visible than check boxes or circles that need to be checked or filled in.

At a step S304, an option designation mark 108, which is one of plurality of option designation marks 110, is placed directly on one or more print option symbols of plurality of print option symbols 74 on selection sheet 90 to designate one or more desired print option of plurality of print options 76 to be used in printing the desired image or images.

Each image of plurality of images 56 on which an action is to be taken includes at least a first image on which the action is to be taken and at least a second image on which the action is to be taken. Accordingly, the user may print different images with different print options. In such a case, the user places an option designation mark 108 directly on at least one print option symbol corresponding to at least one print option 76 for an image upon which an action is to be taken, and places an option designation mark 108 on a different at least one print option symbol corresponding to a different at least one print option 76 for an image upon which the action is to be taken. For example, in FIG. 4, option designation mark 108 in the form of a “scribble” 112 is used to mark print option symbol 84, print option symbol 86, and print option symbol 88 for thumbnail 66, corresponding to image 58 upon which action 94 is to be taken. In addition option designation mark 108, in the form of “scribble” 112, is used to mark print option symbol 114 and print option symbol 88 for thumbnail 67, corresponding to image 59, upon which action 94 is also to be taken. In both cases, action 94 is printing the designated images using the print options 76 selected for each image.

At a step S306, selection sheet 90 is inserted into imaging apparatus 12, for example, into an automatic sheet feeder or a manual feed slot in imaging apparatus 12.

At a step S308, imaging apparatus 12 detects each designation mark by scanning selection sheet 90 with scanner 24. For example, scanner 24 scans selection sheet 90 to detect designation mark 92, a second designation mark, e.g., designation mark 100, and each option designation mark 108. Using the detection algorithms described above, detection step S308 includes detecting the configurations of each designation mark, for example, detecting configuration 104 of designation mark 92 as being hand-drawn circle 82, and detecting configuration 106, respectively, of designation mark 100 as being handwritten “X” 80.

At a step S310, imaging apparatus 12 performs action 94 based on detecting designation mark 92 and based on the known location of each thumbnail, e.g., thumbnail 66. For example, the location of designation mark 92, with respect to the known location of thumbnail 66 at “X” coordinate 124 and “Y” coordinate 126 (reference FIG. 7), allows for a determination by imaging apparatus 12 that thumbnail 66 has been selected. If a print option is selected, step S310 includes printing each image on which an action is to be taken, using the print option, based on the known location of the print option symbol. For example, printing image 58, on which action 94 is to be taken, using a print option 76 based on a known location of print option symbol 84 and the detected location of option designation mark 108. Here, action 94 is printing. Alternatively, however, action 94 may be any action, such as one of the previously described actions, for example, inhibiting image 58 from printing, or deleting image 58 from memory 36 and/or memory 45.

If more than one image is selected for the action of printing, and different print options are desired for each respective image, step S310 includes, for example, printing image 58 using at least one print option 76 of plurality of print options 76, and printing image 59 using a different at least one print option 76 of plurality of print options 76.

If more one action is desired for a particular image or images, and another action is desired for another image or images, step S310 includes performing both such actions on the respective images, without the need to re-mark and reinsert selection sheet 90 into imaging apparatus 12. For example, step S310 includes performing both action 94 on image 58 and action 102 on image 60 based on detecting both designation mark 92 and designation mark 100, and based on detecting, for example, configuration 104 of designation mark 92 in the form of hand-drawn circle 82, and configuration 106 of designation mark 100 in the form of handwritten “X” 80, respectively. Action 94 may be, for example, printing image 58, and action 102 may be, for example, deleting image 60 from memory 36 and/or memory 45.

In a case where the user wishes to print all of plurality of images 56 except for a certain image or certain images, step S310 includes printing all images except for those images designation for the action of inhibiting printing.

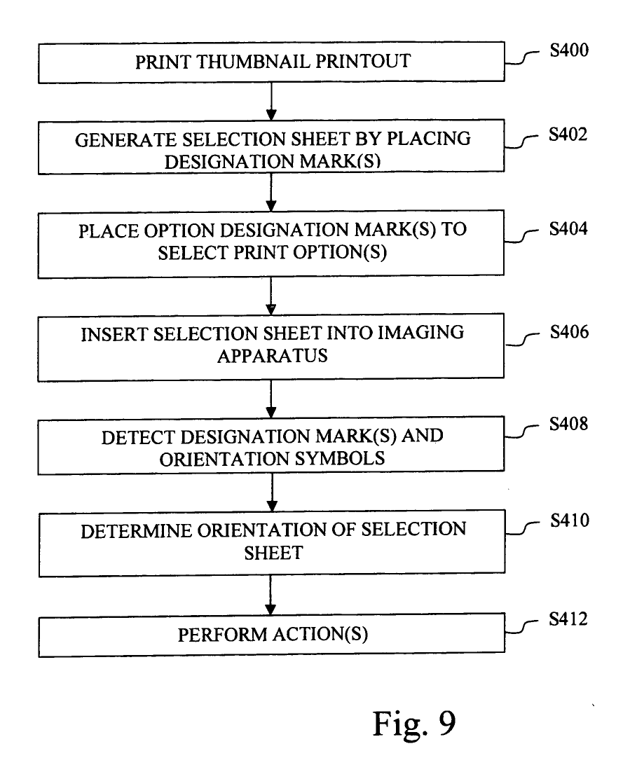

Referring now to FIG. 9, there is generally depicted yet another method for selecting images from the plurality of images 56 obtained from digital device 13 for performing an action, such as printing, with imaging apparatus 12. This method is described primarily with reference to FIG. 4, and also, FIGS. 2A, 2B, and 6-7.

At a step S400, the function of printing thumbnail printout 62 with plurality of thumbnails 64 corresponding to plurality of images 56 is performed, using imaging apparatus 12. Thumbnail printout 62 includes at least one orientation symbol 128 for indicating an orientation of thumbnail printout 62. In addition, thumbnail printout 62 incorporates plurality of print option symbols 74, including, for example, a print option symbol 84, a print option symbol 86, and a print option symbol 88.

Orientation symbol 128 includes at least one elongate bar 130, which is preferably located in a corner 132 of thumbnail printout 62, but may be located on any convenient portion of thumbnail printout 62. As depicted in FIG. 4, orientation symbol 128 includes four orientation symbols, wherein a first orientation symbol 128 is an elongate bar 130, a second orientation symbol 128 is two elongate bars 130, a third orientation symbol is three elongate bars 130, and a fourth orientation symbol is four elongate bars 130. Orientation symbol 128 is configured to indicate at least four possible orientations of thumbnail printout 62, for example, a top orientation 134, a bottom orientation 136, a left orientation 138, and a right orientation 140.

At a step S402 selection sheet 90 is generated from thumbnail printout 62 by placing a designation mark 92 on thumbnail printout 62 for each thumbnail of plurality of thumbnails 64 corresponding to each image of plurality of images 56 on which an action 94 is to be taken. For example, as depicted in FIG. 5A, designation mark 92 in the form of hand-drawn circle 82 is placed adjacent thumbnail 66 corresponding to image 58. In another example, as depicted in FIG. 5B, designation mark 92 in the form of handwritten “X” 80 is placed in check box 96 for thumbnail 66 corresponding to image 58. Alternatively, designation mark 92 may be made by filling in a fill-in circle 98, as depicted in FIG. 5C, or making any other convenient mark. Another designation mark 100 is placed on thumbnail printout 62 for each thumbnail of plurality of thumbnails 64 corresponding to each image of plurality of images 56 on which a another action, such as an action 102, is to be taken, wherein designation mark 100 is different from designation mark 92, and action 102 is different from action 94. As depicted in FIG. 5D, designation mark 100 is placed adjacent thumbnail 68 corresponding to image 60. Designation mark 92 has a configuration 104 in the form of hand-drawn circle 82, and designation mark 100 has a configuration 106, different from configuration 104, in the form of handwritten “X” 80. Action 94 is printing image 58, whereas action 102 is deleting image 60 from memory 36 and/or memory 45.

At a step S404, an option designation mark 108, which is one of plurality of option designation marks 110, is placed at one or more print option symbols of plurality of print option symbols 74 on selection sheet 90 to designate one or more desired print option of plurality of print options 76 to be used in printing the desired image or images.

At a step S406, selection sheet 90 is inserted into imaging apparatus 12, for example, into an automatic sheet feeder or a manual feed slot in imaging apparatus 12.

At a step S408, imaging apparatus 12 detects each designation mark by scanning selection sheet 90 with scanner 24. For example, scanner 24 scans selection sheet 90 to detect designation mark 92, a second designation mark, e.g., designation mark 100, and each option designation mark 108. Using the detection algorithms described above, detection step S408 includes detecting the configurations of each designation mark, for example, detecting configuration 104 of designation mark 92 as being hand-drawn circle 82, and detecting configuration 106, respectively, of designation mark 100 as being handwritten “X” 80.

In addition to detecting designation marks, each orientation symbol 128 is detected by scanning selection sheet 90 with scanner 24.

At a step S410, the orientation of selection sheet 90, e.g., top orientation 134, bottom orientation 136, left orientation 138, or right orientation 140, is determined, based on orientation symbol 128. In the present embodiment, the orientation is determined based on detecting a number of elongate bars. For example, as selection sheet 90 is fed through imaging apparatus 12, if scanner 24 initially detects a single elongate bar 130 at the beginning of scanning of selection sheet 90, imaging apparatus 12 determines the orientation of selection sheet 90 as being top orientation 134, e.g., a portrait orientation with the top end having been inserted into the automatic sheet feeder or manual feed slot of imaging apparatus 12. On the other hand, if scanner 24 initially detects three elongate bars 130, imaging apparatus 12 determines the orientation of selection sheet 90 as being right orientation 140, e.g., a landscape orientation with the right end of selection sheet 90 having been inserted into imaging apparatus 12. It will be understood that bottom orientation 136 and left orientation 138 are similarly detected, based on initially detecting two elongate bars and four elongate bars, respectively. It will also be understood that the orientation may be determined using other numbers and shapes of orientation symbol 128 that are sufficient to indicate at least four possible orientations of thumbnail printout 62.

At a step S412, imaging apparatus 12 performs action 94 based on detecting designation mark 92 and based on the known location of each thumbnail, e.g., thumbnail 66, which is based on the determining of the orientation of selection sheet 90. For example, the location of designation mark 92, with respect to the known location of thumbnail 66 at “X” coordinate 124 and “Y” coordinate 126 (reference FIG. 7), allows for a determination by imaging apparatus 12 that thumbnail 66 has been selected. If a print option is selected, step S412 includes printing each image on which an action is to be taken, using the print option, based on the known location of the print option symbol. For example, printing image 58, on which action 94 is to be taken, using a print option 76 based on the known location of print option symbol 84 and the detected location of option designation mark 108. The location of each print option symbol is known based on the determined orientation of selection sheet 90.

In the example given, action 94 is printing. Alternatively, however, action 94 may be any action, such as one of the previously described actions, for example, inhibiting image 58 from printing, or deleting image 58 from memory 36 and/or memory 45.

If more than one action is desired for a particular image or images, and another action is desired for another image or images, step S412 includes performing both such actions on the respective images, without the need to re-mark and reinsert selection sheet 90 into imaging apparatus 12. For example, step S412 includes performing both action 94 on image 58 and action 102 on image 60 based on detecting both designation mark 92 and designation mark 100 and based on the determined orientation of selection sheet 90, and also based on detecting, for example, configuration 104 of designation mark 92 in the form of hand-drawn circle 82, and configuration 106 of designation mark 100 in the form of handwritten “X” 80, respectively. Action 94 is, for example, printing image 58, and action 102 is, for example, deleting image 60 from memory 36 and/or memory 45.

In a case where the user wishes to print all of plurality of images 56 except for a certain image or certain images, step S412 includes printing all images except for those images designation for the action of inhibiting printing.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for selecting images from a plurality of images obtained from a digital device for printing with an imaging apparatus, said imaging apparatus having a scanner and accessing a memory storing said plurality of images, said method comprising the steps of:
printing a thumbnail printout, said thumbnail printout including a plurality of thumbnails corresponding to said plurality of images;
generating a selection sheet from said thumbnail printout by placing a first designation mark on said thumbnail printout for each thumbnail of said plurality of thumbnails corresponding to each image of said plurality of images on which a first action is to be taken;
detecting said first designation mark by scanning said selection sheet with said scanner;
printing a confirmation for confirming to a user that said each image on which said first action to be taken is designated; and
performing said first action based on said detecting said first designation mark.

2. The method of claim 1, wherein the step of printing said confirmation includes printing said confirmation on said selection sheet.

3. The method of claim 2, wherein said step of printing said confirmation includes printing a first confirmation mark printed at one of a location adjacent said each thumbnail and on said each thumbnail, corresponding to said each image on which said first action is to be taken.

4. The method of claim 2, wherein said step of printing said confirmation includes printing said each thumbnail corresponding to said each image on which said first action is to be taken.

5. The method of claim 2, said thumbnail printout further including a print option symbol, further comprising the step of:
placing an option designation mark at said print option symbol on said selection sheet to designate a print option,
wherein the step of detecting said first designation mark includes detecting said option designation mark;
wherein the step of performing said first action includes printing said each image on which said first action is to be taken using said print option; and
wherein said step of printing said confirmation includes printing an option confirmation mark at one of a location adjacent said print option symbol and on said print option symbol.

6. The method of claim 5, wherein said step of printing said confirmation includes printing said print option symbol.

7. The method of claim 5, wherein:
said print option symbol is one of a plurality of print option symbols;
said print option is one of a plurality of print options; and
said option designation mark is one of a plurality of option designation marks,
wherein said each image of said plurality of images on which said first action is to be taken includes a first image on which said first action is to be taken and a second image on which said first action is to be taken;
said step of performing said first action includes printing said first image using at least one print option of said plurality of print options and printing said second image using a different at least one print option of said plurality of print options; and
said step of printing said confirmation includes printing said option confirmation mark at print option symbols of said plurality of print option symbols corresponding to said at least one print option and said different at least one print option.

8. The method of claim 1, wherein the step of performing said first action includes printing.

9. The method of claim 1, wherein the step of performing said first action includes inhibiting printing.

10. The method of claim 1, wherein the step of performing said first action includes deleting from said memory.

11. The method of claim 1, wherein:
the step of generating said selection sheet further includes placing a second designation mark on said thumbnail printout for each thumbnail of said plurality of thumbnails corresponding to each image of said plurality of images on which a second action is to be taken, said second designation mark being different from said first designation mark, and said second action being different from said first action;
the step of detecting includes detecting both said first designation mark and said second designation mark by scanning said selection sheet with said scanner;
the step of performing includes performing both said first action and said second action based on said detecting both said first designation mark and said second designation mark respectively; and
wherein the step of printing said confirmation includes printing a first confirmation mark and a second confirmation mark different from said first confirmation mark.

12. The method of claim 11, wherein said first action is printing, and said second action is deleting from said memory.

13. The method of claim 11, wherein said first designation mark has a first configuration, and said second designation mark has a second configuration different from said first configuration, wherein:
said detecting both said first designation mark and said second designation mark includes detecting said first configuration and said second configuration respectively; and
said performing both said first action and said second action is based on said detecting said first configuration and said second configuration respectively.

14. The method of claim 13, wherein said first action is printing, and wherein said second action is deleting from said memory.

15. The method of claim 11, wherein the step of printing said confirmation includes printing said confirmation on said selection sheet.

16. The method of claim 1, wherein said scanner is an alignment sensor used for aligning a printhead of said imaging apparatus.

17. A method for selecting images from a plurality of images obtained from a digital device for printing with an imaging apparatus, said imaging apparatus having a scanner and accessing a memory storing said plurality of images, said method comprising the steps of:
printing a thumbnail printout, said thumbnail printout including a plurality of thumbnails corresponding to said plurality of images;
generating a selection sheet from said thumbnail printout by placing a first designation mark directly on each thumbnail of said plurality of thumbnails corresponding to each image of said plurality of images on which a first action is to be taken;
detecting said first designation mark by scanning said selection sheet with said scanner; and
performing said first action based on said detecting said first designation mark.

18. The method of claim 17, wherein said first designation mark is an alpha-numeric symbol.

19. The method of claim 17, wherein the step of performing said first action is based on a known location of said each thumbnail corresponding to said each image on which said first action is to be taken.

20. The method of claim 17, said thumbnail printout further including a print option symbol, further comprising the step of:
placing an option designation mark directly on said print option symbol on said selection sheet to designate a print option,
wherein the detecting step includes detecting said option designation mark; and
wherein the step of performing said first action includes printing said each image on which said first action is to be taken using said print option based on a known location of said print option symbol.

21. The method of claim 20, wherein said print option symbol is one of a plurality of print option symbols, said option designation mark is one of a plurality of option designation marks, and said print option is one of a plurality of print options.

22. The method of claim 21, wherein each image of said plurality of images on which said first action is to be taken includes a first image on which said first action is to be taken and a second image on which said first action is to be taken, said step of said performing said first action including printing said first image using at least one print option of said plurality of print options and printing said second image using a different at least one print option of said plurality of print options.

23. The method of claim 17, wherein the step of performing said first action includes printing.

24. The method of claim 17, wherein the step of performing said first action includes inhibiting printing.

25. The method of claim 17, wherein the step of performing said first action includes deleting from said memory.

26. The method of claim 17, wherein:
the step of generating said selection sheet further includes placing a second designation mark directly on each thumbnail of said plurality of thumbnails corresponding to each image of said plurality of images on which a second action is to be taken, said second designation mark being different from said first designation mark, and said second action being different from said first action;
the step of detecting includes detecting both said first designation mark and said second designation mark by scanning said selection sheet with said scanner; and
the step of performing includes performing both said first action and said second action based on said detecting both said first designation mark and said second designation mark respectively.

27. The method of claim 26, wherein said first action is printing, and said second action is deleting from said memory.

28. The method of claim 26, wherein said first designation mark has a first configuration, and said second designation mark has a second configuration different from said first configuration, wherein:
said detecting said both said first designation mark and said second designation mark includes detecting said first configuration and said second configuration respectively; and
said performing both said first action and said second action is based on said detecting said first configuration and said second configuration respectively.

29. The method of claim 28, wherein said first action is printing, and wherein said second action is deleting from said memory.

30. The method of claim 17, wherein said scanner is an alignment sensor used for aligning a printhead of said imaging apparatus.

31. A method for selecting images from a plurality of images obtained from a digital device for printing with an imaging apparatus, said imaging apparatus having a scanner and accessing a memory storing said plurality of images, said method comprising the steps of:
printing a thumbnail printout, said thumbnail printout including a plurality of thumbnails corresponding to said plurality of images and at least one orientation symbol for indicating an orientation of said thumbnail printout;
generating a selection sheet from said thumbnail printout by placing a first designation mark on said thumbnail printout for each thumbnail of said plurality of thumbnails corresponding to each image of said plurality of images on which a first action is to be taken;
detecting said first designation mark by scanning said selection sheet with said scanner;
detecting said at least one orientation symbol by scanning said selection sheet with said scanner;
determining said orientation of said selection sheet based on said at least one orientation symbol; and
performing said first action based on said detecting said first designation mark and based on said determining said orientation.

32. The method of claim 31, wherein said at least one orientation symbol includes at least one elongate bar.

33. The method of claim 32, wherein said at least one elongate bar is printed in at least one corner of said thumbnail printout.

34. The method of claim 33, wherein said at least one orientation symbol is configured to indicate at least four possible orientations of said thumbnail printout.

35. The method of claim 34, wherein said at least one orientation symbol is at least four orientation symbols.

36. The method of claim 35, wherein a first orientation symbol is an elongate bar, a second orientation symbol is two elongate bars, a third orientation symbol is three elongate bars, and a fourth orientation symbol is four elongate bars.

37. The method of claim 36, wherein said orientation is determined based on detecting a number of elongate bars.

38. The method of claim 31, wherein the step of performing said first action is based on a known location of said at least one thumbnail based on the step of determining said orientation.

39. The method of claim 31, said thumbnail printout further including a print option symbol, further comprising the step of:
placing an option designation mark at said print option symbol on said selection sheet to designate a print option,
wherein the step of detecting said first designation mark includes detecting said option designation mark;
wherein the step of performing said first action includes printing said each image on which said first action is to be taken using said print option; and
wherein the step of performing said first action is based on a known location of said print option symbol based on the step of determining said orientation.

40. The method of claim 31, wherein the step of performing said first action includes printing.

41. The method of claim 31, wherein the step of performing said first action includes inhibiting printing.

42. The method of claim 31, wherein the step of performing said first action includes deleting from said memory.

43. The method of claim 31, wherein said scanner is an alignment sensor used for aligning a printhead of said imaging apparatus.

44. The method of claim 31, wherein:
the step of generating said selection sheet further includes placing a second designation mark on said thumbnail printout for each thumbnail of said plurality of thumbnails corresponding to each image of said plurality of images on which a second action is to be taken, said second designation mark being different from said first designation mark, and said second action being different from said first action;
the step of detecting said first designation mark includes detecting both said first designation mark and said second designation mark by scanning said selection sheet with said scanner; and
the step of performing includes performing both said first action and said second action based on said detecting both said first designation mark and said second designation mark respectively and based on the step of determining said orientation.

45. The method of claim 44, wherein said first action is printing, and said second action is deleting from said memory.

46. The method of claim 44, wherein said first designation mark has a first configuration, and said second designation mark has a second configuration different from said first configuration, wherein:
said detecting said both said first designation mark and said second designation mark includes detecting said first configuration and said second configuration respectively; and
said performing both said first action and said second action is based on said detecting said first configuration and said second configuration respectively.

47. The method of claim 46, wherein said first action is printing, and wherein said second action is deleting from said memory.

48. A method for selecting images from a plurality of images obtained from a digital device for printing with an imaging apparatus, said imaging apparatus having a scanner and accessing a memory storing said plurality of images, said method comprising the steps of:
printing a thumbnail printout, said thumbnail printout including a plurality of thumbnails corresponding to said plurality of images;
generating a selection sheet from said thumbnail printout by:
placing a first designation mark on said thumbnail printout for each thumbnail of said plurality of thumbnails corresponding to each image of said plurality of images on which a first action is to be taken; and
placing a second designation mark on said thumbnail printout for each thumbnail of said plurality of thumbnails corresponding to each image of said plurality of images on which a second action is to be taken, said second designation mark being different from said first designation mark, and said second action being different from said first action;
detecting said first designation mark and said second designation mark by scanning said selection sheet with said scanner;
performing said first action based on said detecting said first designation mark; and
performing said second action based on said detecting said second designation mark.

49. The method of claim 48, wherein said first action is printing, and said second action is deleting from said memory.

50. The method of claim 48, wherein said first designation mark has a first configuration, and said second designation mark has a second configuration different from said first configuration, wherein:
the step of detecting said first designation mark and said second designation mark includes detecting said first configuration and detecting said second configuration respectively;
the step of performing said first action is based on said detecting said first configuration; and
the step of performing said second action is based on said detecting said second configuration.

51. The method of claim 48, said thumbnail printout further including a print option symbol, further comprising the steps of:
placing an option designation mark at said print option symbol on said selection sheet to designate a print option; and
detecting said option designation mark by scanning said selection sheet with said scanner,
wherein the step of performing said first action includes printing each said image on which said first action is to be taken using said print option.

52. The method of claim 51, wherein:
said print option symbol is one of a plurality of print option symbols;
said print option is one of a plurality of print options; and
said option designation mark is one of a plurality of option designation marks,
wherein each image of said plurality of images on which said first action is to be taken includes a first image on which said first action is to be taken and a second image on which said first action is to be taken; and
the step of performing said first action includes printing said first image using at least one print option of said plurality of print options and printing said second image using a different at least one print option of said plurality of print options.

53. The method of claim 48, wherein said scanner is an alignment sensor used for aligning a printhead of said imaging apparatus.
